(19) United States
(12) Patent Application Publication
(10) Pub. No.: US 2026/0361371 A1
(43) Pub. Date: Nov. 12, 2026

(54) ENERGY SAVING

(71) Applicant: Nokia Technologies Oy, Espoo (FI)

(72) Inventors: Anna PANTELIDOU, Antony (FR); Daniela LASELVA, Klarup (DK)

(73) Assignee: Nokia Technologies Oy, Espoo (FI)

(21) Appl. No.: 19/125,447

(22) PCT Filed: Oct. 5, 2023
(86) PCT No.: PCT/EP2023/077588

§ 371 Date: Apr. 29, 2025

(30) Foreign Application Priority Data
Nov. 2, 2022 (FI) 20225981

(51) Int. Cl. H04B 7/06; H04W 24/08; H04W 24/10; H04W 52/02

(52) U.S. Cl. CPC H04B 7/0695; H04W 24/08; H04W 24/10; H04W 52/0206

(57) ABSTRACT

The present disclosure relates to energy saving. An apparatus receives a logged measurement configuration, from an access node, for collecting information from at least one dormant beam for an energy saving operation. The apparatus monitors a reference signal of at least one beam in accordance with the configuration. When detecting the at least one beam is dormant, the apparatus logs measurement information on the at least one beam. The apparatus transmits the logged measurement information to the access node.

### FIELD

The present disclosure generally relates to the field of telecommunication and in particular, to apparatus, access nodes, methods and computer readable storage media for enhancements for energy saving.

### BACKGROUND

Reducing energy consumption of mobile networks, and particularly of a radio access network (RAN) has gained significant attention because RAN consumes the largest part of total energy consumption in a network.

Currently, network energy saving (NES) may be achieved using network proprietary solutions. The network proprietary solutions may comprise infrequent Synchronization Signal Block (SSB) transmission, for example, SSB periodicity of 160 ms, could be considered in empty or low load situation in Fifth Generation (5G) Non-Standalone deployments. The network proprietary solutions may also comprise micro discontinuous transmission (DTx) in symbols that do not carry data nor signaling, which consists in shutting down the Power Amplifier (PA) on a per Orthogonal Frequency Division Multiple (OFDM) symbol basis. In addition, according to the network proprietary solutions, further components could be shut down based on network architecture and capability. Furthermore, the network proprietary solutions may also comprise switching off one or more cells, for example, at a given frequency layer, and hence to switch off most of hardware components of the corresponding Radio Unit and/or RAN site.

### SUMMARY

In general, the present disclosure provides a solution for energy saving.

In a first aspect, there is provided an apparatus. The apparatus comprises at least one processor and at least one memory storing instructions. When the instructions are executed by the at least one processor, the instructions cause the apparatus at least to: receive a logged measurement configuration, from an access node, for collecting information from at least one dormant beam for an energy saving operation; monitor a reference signal of at least one beam in accordance with the configuration; when detecting the at least one dormant beam, log measurement information on the at least one dormant beam, and transmit the logged measurement information to the access node.

In a second aspect, there is provided an access node. The access node comprises at least one processor and at least one memory storing instructions. When the instructions are executed by the at least one processor, the instructions cause the access node at least to: transmit, to at least one apparatus, a logged measurement configuration for collecting information from at least one dormant beam for an energy saving operation; and receive, from the at least one apparatus, logged measurement information on the at least one dormant beam.

In a third aspect, there is provided an access node. The access node comprises at least one processor and at least one memory storing instructions. When the instructions are executed by the at least one processor, the instructions cause the access node at least to: transmit, to a further access node, a request for a load measurement of at least one dormant beam; and receive the load measurement from the further access node.

In a fourth aspect, there is provided a method. The method may be performed by an apparatus and comprises: receiving a logged measurement configuration, from an access node, for collecting information from at least one dormant beam for an energy saving operation; monitoring a reference signal of at least one beam in accordance with the configuration; logging measurement information on the at least one dormant beam when detecting the at least one dormant beam, and transmitting the logged measurement information to the access node.

In a fifth aspect, there is provided a method. The method may be performed by an access node and comprises: transmitting, to at least one apparatus, a logged measurement configuration for collecting information from at least one dormant beam for an energy saving operation; and receiving, from the at least one apparatus, logged measurement information on the at least one dormant beam.

In a sixth aspect, there is provided a method. The method may be performed by an access node and comprises: transmitting, to a further access node, a request for a load measurement of at least one dormant beam; and receiving the load measurement from the further access node.

In a seventh aspect, there is provided an apparatus. The apparatus comprises: means for receiving a logged measurement configuration, from an access node, for collecting information from at least one dormant beam for an energy saving operation; means for monitoring a reference signal of at least one beam in accordance with the configuration; means for logging measurement information on the at least one beam when detecting the at least one beam is dormant, and means for transmitting the logged measurement information to the access node.

In an eighth aspect, there is provided an access node. The access node comprises: means for transmitting, to at least one apparatus, a logged measurement configuration for collecting information from at least one dormant beam for an energy saving operation; and means for receiving, from the at least one apparatus, logged measurement information on the at least one dormant beam.

In a ninth aspect, there is provided an access node. The access node comprises: means for transmitting, to a further access node, a request for a load measurement of at least one dormant beam; and means for receiving the load measurement from the further access node.

In a tenth aspect, there is provided a computer readable medium. The computer readable medium comprises program instructions that, when executed by at least one processor, cause an apparatus to perform at least the method according to the fourth aspect.

In an eleventh aspect, there is provided a computer readable medium. The computer readable medium comprises program instructions that, when executed by at least one processor, cause an apparatus to perform at least the method according to the fifth aspect.

In a twelfth aspect, there is provided a computer readable medium. The computer readable medium comprises program instructions that, when executed by at least one processor, cause an apparatus to perform at least the method according to the sixth aspect.

In a thirteenth aspect of the present disclosure, there is provided a computer program product. The computer program product is tangibly stored on a non-transient machine-readable medium and comprises machine-executable instructions, the instructions, when executed on a device, causing the device to execute the method according to any of the fourth to sixth aspects of the present disclosure.

It is to be understood that the summary section is not intended to identify key or essential features of examples of the present disclosure, nor is it intended to be used to limit the scope of the present disclosure. Other features of the present disclosure will become easily comprehensible through the following description.

### BRIEF DESCRIPTION OF THE DRAWINGS

Some examples will now be described with reference to the accompanying drawings, where:

FIG. 1 illustrates an example communication network in which examples of the present disclosure may be implemented;

FIG. 2 illustrates a signaling chart illustrating a process for energy saving in accordance with some examples of the present disclosure;

FIG. 3 illustrates a signaling chart illustrating a process for energy saving in accordance with other examples of the present disclosure;

FIG. 4 illustrates a signaling chart illustrating a process for exchanging load measurement of a dormant beam in accordance with some examples of the present disclosure;

FIG. 5 illustrates a signaling chart illustrating a process for exchanging load measurement of a dormant beam in accordance with some examples of the present disclosure;

FIG. 6 illustrates a flowchart of a method implemented at an apparatus in accordance with the present disclosure;

FIG. 7 illustrates a flowchart of a method implemented at an access node in accordance with the present disclosure;

FIG. 8 illustrates a flowchart of a method implemented at an access node in accordance with the present disclosure;

FIG. 9 illustrates a simplified block diagram of an apparatus that is suitable for implementing examples of the present disclosure; and

FIG. 10 illustrates a block diagram of an example computer readable medium in accordance with some examples of the present disclosure.

Throughout the drawings, the same or similar reference numerals represent the same or similar element.

### DETAILED DESCRIPTION

Principle of the present disclosure will now be described with reference to some examples. It is to be understood that these examples are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one example,” “an example,” and the like indicate that the example described may include a particular feature, structure, or characteristic, but it is not necessary that every example includes the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of examples. As used herein, the term “and/or” includes any and all combinations of one or more of the listed terms.

The terminology used herein is for the purpose of describing particular examples only and is not intended to be limiting of examples. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Examples of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. An RAN split architecture comprises a gNB-CU (Centralized unit, hosting RRC, SDAP and PDCP) controlling a plurality of gNB-DUs (Distributed unit, hosting RLC, MAC and PHY).

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

Although functionalities described herein can be performed, in various examples, in a fixed and/or a wireless network nod, in other examples, functionalities may be implemented in a user equipment apparatus (such as a cell phone or tablet computer or laptop computer or desktop computer or mobile IoT device or fixed IT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

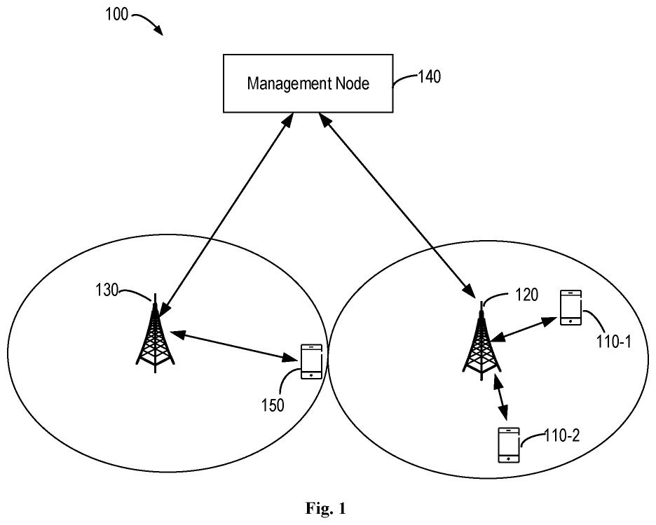

FIG. 1 shows an example communication network 100 in which examples of the present disclosure can be implemented. The network 100 may comprise apparatuses 110-1, 110-2 and 150, access nodes 120 and 130, and a management node 140 that can communicate with each other. Hereinafter, for brevity, the apparatuses 110-1 and 110-2 may be collectively referred to as apparatuses 110 or individually referred to as an apparatus 110.

In some examples, each of the apparatuses 110 and 150 may be implemented as a terminal device in an RAN. In such examples, each of the access nodes 120 and 130 may be implemented as a network device in the RAN. For example, each of the access nodes 120 and 130 may be implemented as a gNB. For another example, each of the access nodes 120 and 130 may be implemented as a network entity which is controlled by the gNB, such as a cell, a Distributed Unit (DU), or a Centralized Unit (CU).

In some examples, the management node 140 may be implemented as a network device in the RAN or in a core network. Alternatively, the management node 140 may be implemented as an Operation and Maintenance (OAM) device.

In some examples, the access node 120 may be serving the apparatuses 110-1 and 110-2, and the access node 130 may be serving the apparatus 150. In such examples, the access node 120 may be referred to as a serving gNB for the apparatuses 110-1 and 110-2, and the access node 130 may be referred to as a neighbor gNB for the apparatuses 110-1 and 110-2. Similarly, the access node 130 may be referred to as a serving gNB for the apparatus 150 and the access node 120 may be referred to as a neighbor gNB for the apparatus 150.

It is to be understood that the number of apparatuses, access nodes and management node is only for the purpose of illustration without suggesting any limitations. The network 100 may include any suitable number of apparatuses, access nodes and management node adapted for implementing examples of the present disclosure. Although not shown, it would be appreciated that more apparatuses may be served by the access nodes 120 and 130, respectively. In addition, it would be appreciated that there may be more neighbor gNB near the apparatuses 110.

Communications in the communication network 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In some examples, energy saving operation may be performed in the communication network 100. For example, energy saving operation may be performed by at least one of the access nodes 120 and 130.

One of the energy saving options discussed at the Energy Saving Study Item (SI) is to control the switching on or off of energy saving cells in overlaid scenarios with finer granularity, including at beam level. This may be achieved by reducing the number of beams sent by at least one of the access nodes 120 and 130 and putting beams in a dormant state. Hereinafter, a beam in the dormant state may be referred to as a dormant beam.

In some examples, dormant beams may be woken up on-demand based on the actual need in order to enable efficient offloading of traffic in the communication network 100. Two different dormancy states may be considered. One of the two different dormancy states is long-scale dormancy where a beam is put to dormant state in the lack of any terminal devices in its coverage area. The other of the two different dormancy states is short-scale dormancy where a beam may be woken up if some terminal devices are present in its coverage area.

One option to wake up a dormant beam is to allow a wake-up signal (WUS) to be transmitted from a terminal device to wake up a beam in the dormant state. The terminal device may transmit the wake-up signal to one of the access nodes 120 and 130 when it comes in range of a beam which is in the dormant state.

Whenever the access node 120 or 130 operates in an NES mode such as having one or more beams in a cell in the dormant state, this entails that some of its hardware components are switched off or kept in a sleep mode to obtain network energy reduction. For example, a PA of the access node 120 or 130 may be switched off during the symbols or slot where SSBs are omitted at least partially because the corresponding SSB beam is in the dormant state. As a result, capabilities of the access node 120 or 130 (or the RAN in a given area) to provide services or high performance (for example, high Signal to Interference plus Noise Ratio or high data rate) to end users may be temporarily reduced until the NES mode is exited.

Accordingly, there may be a trade-off between the energy to be saved and performance to be provided, which may depend on the load level and subscriber types. For example, the provided performance during the NES mode (for example, in terms of bit rate, latency, the number of served terminal devices, amount of data, and so on) may be limited or degraded. To enable increased performance or revert to the normal performance level, the access node 120 or 130 may want to exit the NES mode. However, this comes at the price of an increased energy consumption. Therefore, the access node 120 or 130 needs to determine when energy saving should be traded off in favour of performance, and vice versa. Such trade-off depends, for example, on how many terminal devices would benefit from increased performance.

In order for the access node 120 or 130 to best determine whether to wake up a dormant beam or not, the access node 120 or 130 needs to know how many terminal devices are in the range of the dormant beam. The access node 120 or 130 cannot know the number of terminal devices that have been monitoring or listening to the dormant beam if either relaxed SSBs or CSI-RSs or lean SSBs are transmitted. Furthermore, the access node 120 or 130 cannot know amounts of data to be transmitted by the terminal devices for the dormant beam. In addition, the access node 120 or 130 cannot know the number of terminal devices that may benefit from operating in the dormant beam if no SSBs or CSI-RSs are transmitted.

The present disclosure provides a solution for energy saving. In the solution, an apparatus receives a logged measurement configuration, from an access node, for collecting information from at least one dormant beam for an energy saving operation. The apparatus monitors a reference signal of at least one beam in accordance with the configuration. When detecting the at least one dormant beam, the apparatus logs measurement information on the at least one dormant beam. In turn, the apparatus transmits the logged measurement information to the access node.

In the solution, upon receiving the logged measurement information from one or more apparatus, the access node may determine a predicted load measurement of the at least one dormant beam based at least on the logged measurement information. In turn, the access node may determine, based on the predicted load measurement, whether to activate the at least one dormant beam.

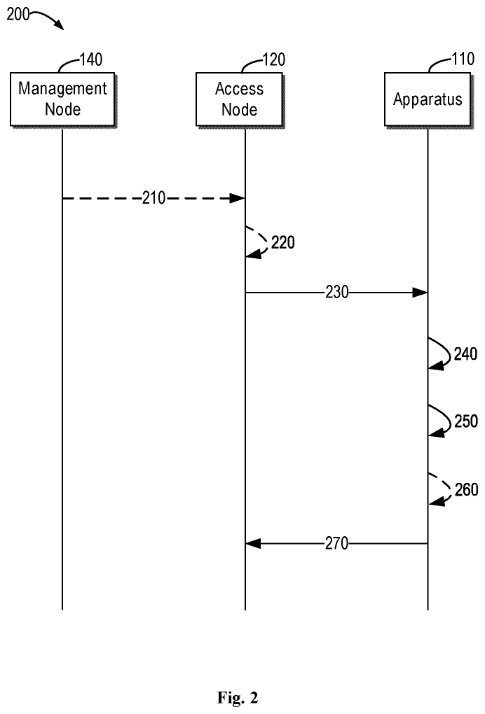

Hereinafter, some examples of the present disclosure according to the first aspect will be described with reference to FIGS. 2 to 8.

FIG. 2 illustrates a signaling chart illustrating a process 200 for energy saving in accordance with some examples of the present disclosure. The process 200 will be described with reference to FIG. 1 from the point of view of the apparatus 110, the access node 120 and the management node 140. Alternatively, in other examples, the process 200 may involve the apparatus 150, the access node 130 and the management node 140 in FIG. 1.

As shown in FIG. 2, the access node 120 transmits 230 a logged measurement configuration, to the apparatus 110, for collecting information from at least one dormant beam for an energy saving operation.

In some examples, the logged measurement configuration may be referred to as a logged Minimization of Drive Tests (MDT) configuration.

In some examples, before transmitting the logged MDT configuration to the apparatus 110, the access node 120 may obtain 210 the logged MDT configuration from the management node 140. In turn, the access node 120 may store 220 the logged MDT configuration and parameters in the logged MDT configuration.

In some examples, the logged MDT configuration may be a signaling-based MDT which is targeting a specific UE (such as the apparatus 110-1). Alternatively, the logged MDT configuration may be a management-based MDT which is targeting an area of cells that may comprise a group of UEs (such as the apparatuses 110-1 and 110-2).

In some examples, the access node 120 may transmit the logged MDT configuration to a plurality of UEs meeting the area constraints, such as the apparatuses 110-1 and 110-2.

In examples where the signaling-based MDT configuration is used, apparatuses (such as UEs) receiving the configuration may be determined by the management node 140 using identifiers of the apparatuses and are apparatuses that have provided the needed user consent. Examples of the identifiers may comprise at least one of the following: IMSI/IMEI/SUPI.

In examples where the management-based MDT is used, in baseline MDT procedures, UEs receiving the configuration may be selected by the access node 120 in an implementation specific way such that the UEs meet the area requirements.

In some examples, the access node 120 may transmit the logged MDT configuration to the apparatus 110 that has been connected to a cell in energy saving mode (for example, a cell that has put some beams in dormancy) or that have neighbour cells in energy saving mode (for example, neighbour cells that have put some beams in dormancy).

In some examples, the logged MDT configuration may be provided as follows:

```
LoggedEventTriggerConfig-r18 ::=  SEQUENCE {
  eventType-r18  EventType-r18,
  loggingInterval-r18  LoggingInterval-r18,
  . . .
}
EventType-r18 ::= CHOICE {
  dormantBeamDetected  NULL,
  dormantBeamList BeamList  OPTIONAL
  dormantBeamAreaConfiguration Area Configuration OPTIONAL // this can be an
alternative to dormantBeamList
  . . .
}
```

The event “dormantBeamDetected” indicates the apparatus 110 to log measurement information on the at least one dormant beam when the apparatus 110 enters a “dormantBeamDetected” state. In some examples, the apparatus 110 enters the “dormantBeamDetected” state the first time it detects a dormant beam. If the apparatus 110 detects a non-dormant beam, it could exit the “dormantBeamDetected” state and attempt connection to the beam. But if the apparatus 110 does not attempt connection to the access node 120, then it skips logging information of the non-dormant beam and continues the monitoring of dormant beams.

In some examples, the event “dormantBeamDetected” may be detected in a limited set of dormant beams (provided by the “dormantBeamList” in the configuration) or by defining the “dormantBeamAreaConfiguration” in which dormant beams can be detected. The “dormant Beam Area Configuration” may comprise a number of cells with energy saving mode activated (where some of the supported beams are dormant).

In some examples, if the “dormantBeamList” or the “dormantBeamAreaConfiguration” is included in the logged MDT configuration, the apparatus 110 may only collect information from dormant beams limited by the logged MDT configuration. If those two fields are not included in the logged MDT configuration, the apparatus 110 may monitor beams in an unrestricted way.

Upon receiving the logged measurement configuration, the apparatus 110 monitors 240 a reference signal (RS) of at least one beam in accordance with the configuration.

In some examples, the apparatus 110 may monitor the reference signal of the at least one beam in response to receiving a logged measurement activation.

In such examples, the logged measurement activation may comprise an energy saving indication indicating the apparatus 110 to collect information for an energy saving operation. The logged measurement activation may also comprise an Area Scope. The Area Scope may be set to be the “dormantBeamAreaConfiguration” (i.e., a set of cells).

In some examples, the dormant beam may be an SSB beam or Channel State Information Reference Signal (CSI-RS) beam.

The beam targeted by the present disclosure may be of any reference signal type such as an SSB beam, a Channel State Information Reference Signal (CSI-RS) beam, a Tracking Reference Signal (TRS) beam, a Phase-tracking reference signal (PT-RS) beam, or of a new reference signal type that may be defined in future releases/technologies. When such beam of a first reference signal type (e.g. SSB) is dormant, the access node 120 and/or 130 may transmit reference signals of a second type for the beam. The second type may be the same as the first type (for example, SSB, which may be sent e.g. with a relaxed periodicity, or in an incomplete manner for example including PSS/SSS only), or it may be different from the first type (e.g. of a dormant type such as a discovery reference signal type, DRS).

In some examples, the apparatus 110 may determine a beam is a dormant beam by determining an RS of the beam is of a dormant type. For example, if the apparatus 110 detects that the RS of the beam is a beam-tracking RS defined for dormant beams, the apparatus 110 may determine the beam is a dormant beam. The beam-tracking RS may comprise at least one of the following: Primary synchronization signal (PSS) and Secondary synchronization signal (SSS). The beam-tracking RS may not be used for initial access of the apparatus 110.

In some examples, the apparatus 110 may determine the beam is a dormant beam by determining at least one common channel or signal of the beam is not transmitted. For example, Master Information Block (MIB) or System Information Block 1 (SIB1) may not be transmitted for a dormant beam. MIB or SIB1 may contain a signal for initial access. Thus, a signal for initial access may not be transmitted for a dormant beam. Thereby, the beam may be distinguished from normal (i.e., non-dormant) beams by the apparatus 110 since it transmits different information and it may not allow initial access.

In some examples, the apparatus 110 may determine the beam is a dormant beam by receiving an indication of dormancy for the beam from the access node 120.

With continued reference to FIG. 2, when detecting the at least one dormant beam, the apparatus 110 logs 250 measurement information on the at least one dormant beam.

In some examples, the logged measurement information on the at least one dormant beam may comprise at least one of the following: an identifier of the at least one dormant beam, an identifier of a beam-tracking RS detected for the at least one dormant beam, a time stamp when the at least one dormant beam was monitored, a time duration when the at least one dormant beam was monitored by the apparatus 110, amount of data to be transmitted by the apparatus 110 during the time duration, or a location of the apparatus 110.

Alternatively, or additionally, in some examples, the logged measurement information may comprise at least one of the following: a first indication whether the apparatus 110 had transmitted a wake-up signal to the at least one dormant beam and obtained no response, or time when the wake-up signal was transmitted.

Alternatively, or additionally, in some examples, the logged measurement information may comprise at least one of the following:
a second indication whether the apparatus 110 used a non-dormant beam or a non-dormant cell for transmitting data,
an identifier of the non-dormant beam or the non-dormant cell,
an identifier of a strongest non-dormant beam detected along with the at least one dormant beam,
an identifier of a cell comprising the strongest non-dormant beam,
radio quality of the at least one dormant beam, or
radio quality of the strongest non-dormant beam.

In some examples, the logged MDT configuration in the present disclosure is provided by extending legacy logged MDT configuration beyond detection of “out of coverage by a UE” (also called as “any cell selection state”). In the “any cell selection state”, the UE cannot detect a suitable cell to connect to because it is out of coverage.

The legacy logged MDT configuration for logging measurement information on the any cell selection state may be as follows:

```
LoggedEventTriggerConfig-r16 ::=  SEQUENCE {
  eventType-r16  EventType-r16,
  loggingInterval-r16  LoggingInterval-r16,
  . . .
}
  EventType-r16 ::= CHOICE {
  outOfCoverage  NULL,
  eventL1  SEQUENCE {
    11-Threshold  MeasTriggerQuantity,
    hysteresis  Hysteresis,
    timeToTrigger  TimeToTrigger
  },
  . . .
}
```

In the legacy logged MDT configuration, the value “outOfCoverage” indicates a UE to perform logging of measurements when the UE enters any cell selection state, and the value eventL1 indicates the UE to perform logging of measurements when the triggering condition as configured in the event is met for the camping cell in camped normally state.

According to the legacy logged MDT configuration, the UE logs the last cell it detects before it enters out of coverage state (i.e., any cell selection state) since the UE does not detect any cells and does not log anything during any cell selection state.

As described above, in the present disclosure, the “dormantBeamDetected” state is introduced to the legacy Logged MDT configuration. This allows the apparatus 110 to log measurement information on the at least one dormant beam when the apparatus 110 enters the “dormantBeamDetected” state. This entails different logging from the point of view of the apparatus 110.

According to the logged MDT configuration in the present disclosure, the apparatus 110 will not detect any beams to perform RACH to but it will detect the dormant beams which it will log continuously while in the “dormantBeamDetected” state.

When the MDT Configuration is initiated for energy saving, the apparatus 110 should provide logging such that it distinguishes the two possible states, i.e., the “any cell selection state” and the “dormantBeamDetected” state. In the “any cell selection state”, the apparatus 110 cannot detect a suitable cell to connect to because it is out of coverage. In the “dormantBeamDetected” state, the apparatus 110 cannot detect a cell because the cell's beams are in a dormant state.

Since the MDT configuration is initiated to monitor energy saving, the apparatus 110 will distinguish the cause of an out of coverage by further indicating if this is due to a beam being in a dormant state. Thus, in some examples, if the apparatus 110 detects the “any cell selection state”, the apparatus 110 may skip 260 logging measurement information on the any cell selection state.

This enables the access node 120 to determine the reason of out of coverage detection by the apparatus 110 since different actions will be needed by the access node 120. If the apparatus 110 is in real out of coverage, the access node 120 may need to increase the transmission power or tilt the beams accordingly to provide cell coverage. If out of coverage is because a cell is in energy saving mode (for example, if one or more beams are in a dormant state), then the access node 120 may wake up those beams.

With continued reference to FIG. 2, the apparatus 110 transmits 270 the logged measurement information to the access node 120.

In some examples, the apparatus 110 may transmit, to the access node 120, a logged MDT report comprising the logged measurement information.

In some examples, the apparatus 110 may get back to a connected state after coverage is recovered. For example, the apparatus 110 may get back to the connected state by transmitting a wake-up signal to the access node 120 if the “dormantBeamDetected” trigger is met. In turn, the apparatus 110 may transmit the logged measurement information in the connected state.

Alternatively, the apparatus 110 may transmit the logged measurement information in an inactive state. For example, the logged measurement information may be provided as part of a small data transmission procedure while the apparatus 110 remains in the inactive state.

In some examples, the apparatus 110 may transmit the logged measurement information upon receiving a request for the logged measurement information from the access node 120.

In some examples, before transmitting the logged measurement information, the apparatus 110 may transmit, to the access node 120, an indication that the logged measurement information on the at least one dormant beam is available. For example, the indication may be a loggedMeasurementAvailability indicator.

In some examples, the apparatus 110 may transmit the indication that the logged measurement information on the at least one dormant beam is available by transmitting a wake-up signal to the access node 120. The wake-up signal comprises the indication. For example, the indication may be piggy-backed in the wake-up signal from the apparatus 110. For another example, the indication may be indicated in the wake-up signal from the apparatus 110.

In some examples, the apparatus 110 may transmit the indication that the logged measurement information on the at least one dormant beam is available by transmitting the indication after transmitting a wake-up signal to the access node 120.

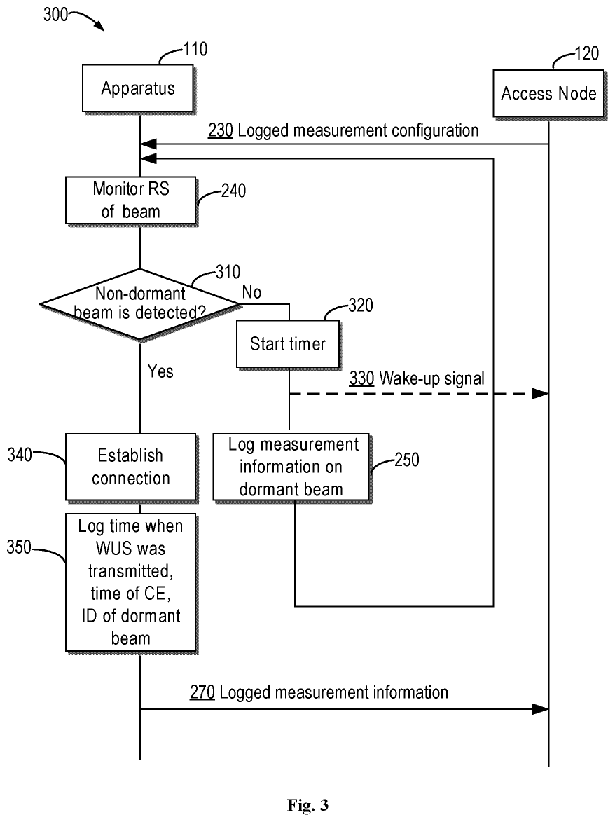

FIG. 3 illustrates a signaling chart illustrating a process 300 for energy saving in accordance with some examples of the present disclosure. The process 300 may be considered as an example implementation of the process 200. The process 300 shows a more detailed view of internal operations in the apparatus 110 upon receiving the logged measurement configuration.

The process 300 will be described with reference to FIG. 1 from the point of view of the apparatus 110 and the access node 120. Alternatively, in other examples, the process 300 may involve the apparatus 150 and the access node 130 in FIG. 1.

The actions 230, 240, 250 and 270 in the process 300 are the same as those in the process 200. Details of these actions are omitted for brevity.

As shown in FIG. 3, at block 310, the apparatus 110 determines whether a non-dormant beam is detected.

In some examples, the apparatus 110 may determine whether a beam is a dormant beam or a non-dormant beam by monitoring the RS of the beam. As described with reference to FIG. 2, if the apparatus 110 detects that the RS of the beam is a beam-tracking RS defined for dormant beams, the apparatus 110 may determine the beam is a dormant beam.

In other examples, no RSs are transmitted for a dormant beam. In other words, a dormant beam may operate in SSB-less mode with no RSs being transmitted. In such examples, the apparatus 110 may monitor an SSB transmitted from an anchor cell having similar or the same pattern with the dormant beam. The apparatus 110 may log information on the SSB transmitted from the anchor cell. Based on the SSB transmitted from the anchor cell, the apparatus 110 may establish the radio quality of a dormant cell (relaying on same frequency properties). The apparatus 110 may acquire information on the dormant SSB and corresponding SSB transmitted from the anchor cell from either the anchor cell or from another non-dormant SSB beam of the energy saving cell.

If the non-dormant beam is not detected, the apparatus 110 starts a timer at block 320. At this stage, the apparatus 110 cannot determine if the lack of detecting a non-dormant beam is due to beam dormancy from the access node 120 or due to the apparatus 110 being in an out-of-coverage state.

In some examples, the timer to identify whether there is a non-dormant or dormant beam may be configured by the access node 120 or may be predefined. A value of the timer may be based on periodicity of the beam-tracking RS for a beam or on periodicity of a corresponding beam from an anchor cell. It shall be noted that the apparatus 110 can eventually differentiate between a dormant beam (either beam-tracking RSs or corresponding beam from an anchor cell is detected) and out-of-coverage (i.e., nothing is detected).

At block 330, the apparatus 110 may transmit a wake-up signal (WUS) to the access node 120 to indicate that it wishes to find an SSB to connect to. It shall be noted that the access node 120 may not necessarily activate a dormant beam upon reception of the WUS from the apparatus 110. The access node 120 may determine whether to activate a dormant beam based on the logged measurement information from the apparatus 110 and from logged measurement information from other apparatuses not shown in this figure. The logged measurement information may indicate at least one of the following: how many WUSs have been transmitted, how long the apparatus 110 monitors the dormant beam, or how much traffic the apparatus 110 wants to transmit to the access node 120.

If the apparatus 110 detects a non-dormant beam, the apparatus 110 may establish a connection with the access node 120 at block 340. For example, the apparatus 110 may attempt to connect to a newly activated beam after reading SIB1 from the beam. The apparatus 110 may log information on a beam to which the apparatus 110 transmitted WUS on and information on a beam which got activated by the access node 120.

At block 350, the apparatus 110 may log time when WUS was transmitted, time of connection establishment (CE) and an identifier (ID) of the dormant beam that was covering the apparatus 110.

In some examples, the access node 120 may determine a load measurement of the at least one dormant beam based at least on the logged measurement information received from at least one apparatus.

In some examples, the access node 120 may receive, from the access node 130, a request for the load measurement of the at least one dormant beam. In turn, the access node 120 may transmit the load measurement to the access node 130 based on the request.

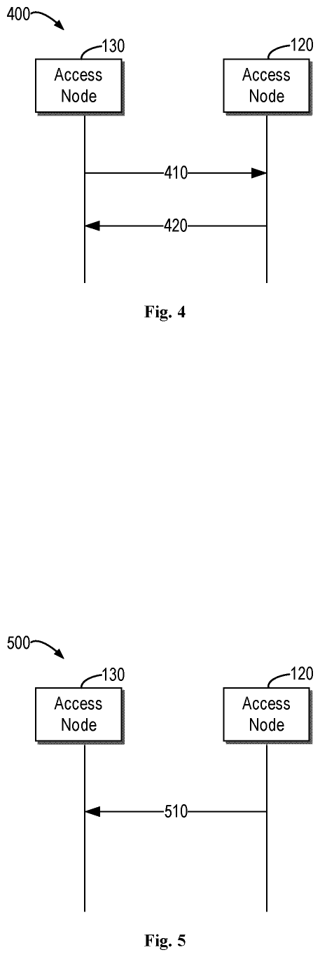

In some examples, the access node 120 may receive the request for the load measurement by using a procedure that is based on a request/response (as shown in FIG. 4) and an additional procedure that is used for the actual reporting (as shown in FIG. 5). This will be described with reference to FIG. 4 and FIG. 5.

FIG. 4 illustrates a signaling chart illustrating a process 400 for exchanging load measurement of a dormant beam in accordance with some examples of the present disclosure. For the purpose of discussion, the process 400 will be described with reference to FIG. 1 from the point of view of the access node 120 and the access node 130.

As shown in FIG. 4, the access node 130 transmits 410, to the access node 120, the request for the load measurement of the at least one dormant beam of the access node 120. In some examples, the access node 130 may transmit the request for the load measurement by transmitting a RESOURCE STATUS REQUEST message. It shall be understood that the RESOURCE STATUS RESPONSE message is just an example, and other messages can be similarly used.

In some examples, the request for the load measurement may indicate measurement ID of the access node 130, a “cells to report list” and an indication that the load measurement of the at least one dormant beam is to be reported.

In some examples, the “cells to report list” may comprise a set of cells where the at least one dormant beam is monitored.

Upon receiving the request, the access node 120 may determine whether it is capable to provide the load measurement of the at least one dormant beam. If the access node 120 is capable to provide the load measurement, the access node 120 initiates the load measurement as requested by the access node 130, and responds 420 to the access node 130 with a response. In some examples, the access node 120 may transmit the response by transmitting a RESOURCE STATUS RESPONSE message. It shall be understood that the RESOURCE STATUS RESPONSE message is just an example, and other messages can be similarly used.

In some examples, the access node 120 may transmit the load measurement by using a reporting procedure. This will be described with reference to FIG. 5.

FIG. 5 illustrates a signaling chart illustrating a process 500 for transmitting load measurement of a dormant beam in accordance with some examples of the present disclosure. The process 500 will be described with reference to FIG. 1 from the point of view of the access node 120 and the access node 130.

As shown in FIG. 5, the access node 120 transmits 510, to the access node 130, the “cells to report list” and the load measurement of the at least one dormant beam. As mentioned above, the “cells to report list” may comprise a set of cells where the at least one dormant beam is monitored.

In some examples, the load measurement of the at least one dormant beam may indicate the number of apparatuses monitoring a first dormant beam among the at least one dormant beam.

In some examples, based at least on the logged measurement information received from a plurality of apparatuses (such as UEs), the access node 120 may determine how many apparatuses have been monitoring different beam-tracking RSs it broadcasts and how long the apparatuses have been monitoring the beam-tracking RSs. In turn, the access node 120 may determine a “Dormant Beam Load” from a number of UEs monitoring the beam-tracking RSs.

For example, the load of a dormant beam can be defined as the number of UEs monitoring the beam in a given time period, e.g. 10 UEs monitor the beam between 10:00 and 10:15 PM. Furthermore, the load of a dormant beam can also account for the amount of load (e.g. user plane data) that the UEs have in their buffer. For example, the load can be defined as the amount of data the UEs have in their buffer while monitoring (or being under the coverage) of the dormant beam, e.g. 10 UEs monitor the dormant beam between 10:00 and 10:15 PM and have in total 500 bits in their buffer during that period.

In a further example, the load of a dormant beam can be defined by the expression

$${\sum }_{i ∈ {I}^{x}} ( {l}_{i}^{x} / {t}_{i}^{x} ,$$

where

$${l}_{i}^{x}$$

is the load (data amount e.g. 100 bit) of UE i monitoring dormant beam RSx, and

$${t}_{i}^{x}$$

is the time duration during which UE i monitors the dormant beam (e.g. 10 seconds). In the given example, the UE i load is given by 1000 bit/10 sec=100 bit/s. In a further variant, the equation above can be calculated per time period (e.g. with 15 min granularity) so that the calculated load level is applicable to e.g. the time period between 10:00 and 10:15 PM.

In a further example, assume that beam-tracking RSx of the first dormant beam is monitored

$${t}_{i}^{x}$$

seconds for a UE i where UE i belongs to a set of UEs monitoring the dormant beam RSx. The set can be indicated by I^{x} where I^{x}={j: UE j monitors dormant beam RSx} (I^{x} is the set of UEs monitoring dormant beam RSx and has cardinality/size |I^{x}|). Then, the Dormant Beam Load of RSx can be given by the expression

$$\frac{{\sum }_{i ∈ {I}^{x}} {t}_{i}^{x}}{\vert {I}^{x} \vert} .$$

This expression is normalized by the number of UEs monitoring the dormant beam, but an alternative expression could be an un-normalized version namely

$${\sum }_{i ∈ {I}^{x}} {t}_{i}^{x}$$

that would give the overall time a dormant beam is monitored by a number of UEs monitoring this dormant beam.

In this way, the access node 120 may determine a Dormant Beam Load per beam-tracking RS. If the Dormant Beam Load is high enough (for example, exceeding a threshold value), then the beam corresponding to the beam-tracking RS is a good candidate to be woken up in case of a handover. This threshold value may be configured by OAM to the access node 120.

Alternatively, or additionally, in some examples, the load measurement of the at least one dormant beam may indicate amounts of data (i.e., traffic) to be transmitted by the apparatuses (such as UEs) monitoring the first dormant beam. For example, a dormant beam that accounts for the load of a UE may be calculated by the expression

$$\frac{{\sum }_{i ∈ {I}^{x}} {l}_{i}^{x} {t}_{i}^{x}}{\vert {I}^{x} \vert} ,$$

where

$${l}_{i}^{x}$$

is the load of UE i monitoring dormant beam RSx (similarly the un-normalized version could be expressed by

$${\sum }_{i ∈ {I}^{x}} {l}_{i}^{x} {t}_{i}^{x}$$

that would give the overall load in a dormant beam.

In some examples, the access node 120 may determine, based on the load measurement, a predicted load measurement of the at least one dormant beam at a future time.

In some examples, the access node 120 may determine the predicted load measurement of the at least one dormant beam by using a machine learning (ML) model. In such examples, the load measurement may be used as an input of the ML model and the predicted load measurement may be an output of the ML model. In some examples, supervised models may be used to train an ML algorithm.

In some examples, the input of the ML model may comprise information on how long a dormant beam is monitored, from how many apparatuses (such as UEs) it is monitored and when it needs to be activated. Base on the information, the access node 120 may determine a dormancy pattern of a beam in the future. For example, the access node 120 may determine whether the beam is active or dormant in an hour.

In some examples, the access node 120 may receive, from the access node 130, a request for the predicted load measurement of the at least one dormant beam. In turn, the access node 120 may transmit the predicted load measurement to the access node 130 based on the request.

In some examples, the access node 120 may determine, based on the predicted load measurement, whether to activate the at least one dormant beam.

In some examples, the access node 130 may determine, based on the received load measurement, the predicted load measurement of the at least one dormant beam at a future time.

In some examples, the access node 130 may determine, based on the predicted load measurement, whether to activate the at least one dormant beam.

In some examples, the access node 130 may determine whether the predicted load measurement is above a threshold. If the predicted load measurement is above the threshold, the access node 130 may transmit, to the access node 120, a request for activating the at least one dormant beam. Alternatively, the access node 130 may transmit, to the access node 120, a handover request or a conditional handover for the at least one dormant beam.

As mentioned above, the load measurement of the at least one dormant beam may indicate the number of UEs monitoring a dormant beam and/or the amount of data to be transmitted if the dormant beam was activated. If there are many UEs that would benefit by activating the dormant beam, the access node 120 or 130 may consider to activate the dormant beam for the UEs which have already monitored the dormant beam. Also, the access node 130 may be able to minimize the number of handovers that require activating of a dormant beam at the neighbouring access node 120 if the benefit would be small (for example, a small number of UEs would get served by the activated beam or the load served by the activated beam would be very small).

In examples where the handover is performed, for example, the apparatus 150 may be handed over to the cell provided by the access node 120.

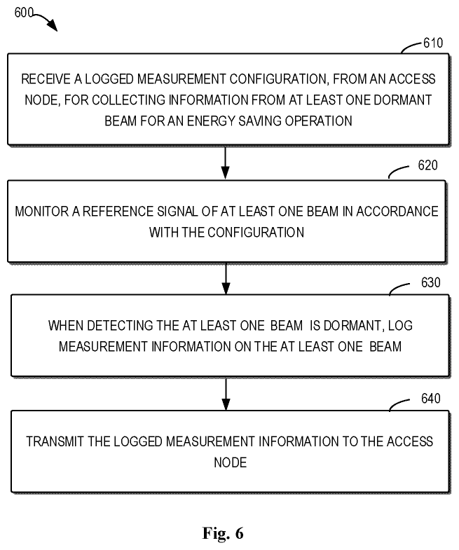

FIG. 6 shows a flowchart of an example method 600 implemented at the apparatus 110 (such as the apparatus 110-1 or 110-2) as shown in FIG. 1.

At block 610, the apparatus 110 receives a logged measurement configuration, from the access node 120, for collecting information from at least one dormant beam for an energy saving operation.

In some examples, the logged measurement configuration may be referred to as a logged MDT configuration.

In some examples, the logged MDT configuration may be a signaling-based MDT which is targeting a specific UE (such as the apparatus 110-1). Alternatively, the logged MDT configuration may be a management-based MDT which is targeting an area of cells that may comprise a group of UEs (such as the apparatuses 110-1 and 110-2).

In examples where the signaling-based MDT configuration is used, apparatuses (such as UEs) receiving the configuration may be determined by the management node 140 using identifiers of the apparatuses and are apparatuses that have provided the needed user consent. Examples of the identifiers may comprise at least one of the following: IMSI/IMEI/SUPI.

In examples where the management-based MDT is used, in baseline MDT procedures, apparatuses (such as UEs) receiving the configuration may be selected by the access node 120 in an implementation specific way such that the apparatuses meet the area requirements.

In some examples, the apparatus 110 receiving the logged MDT configuration may have been connected to a cell in energy saving mode (for example, a cell that has put some beams in dormancy).

In some examples, the logged MDT configuration may be as follows:

```
LoggedEventTriggerConfig-r18 ::=  SEQUENCE {
  eventType-r18  EventType-r18,
  loggingInterval-r18  LoggingInterval-r18,
  . . .
}
EventType-r18 ::= CHOICE {
  dormantBeamDetected  NULL,
  dormantBeamList BeamList  OPTIONAL
  dormantBeamAreaConfiguration Area Configuration OPTIONAL // this can be an
alternative to dormantBeamList
  . . .
}
```

The event “dormantBeamDetected” indicates the apparatus 110 to log measurement information on the at least one dormant beam when the apparatus 110 enters a “dormantBeamDetected” state. In some examples, the apparatus 110 enters the “dormantBeamDetected” state the first time it detects a dormant beam. If the apparatus 110 detects a non-dormant beam, it could exit the “dormantBeamDetected” state and attempt connection to the beam. But if the apparatus 110 does not attempt connection to the access node 120, then it skips logging information of the non-dormant beam and continues the monitoring of dormant beams.

In some examples, the event “dormantBeamDetected” may be detected in a limited set of dormant beams (provided by the “dormantBeamList” in the configuration) or by defining the “dormantBeamAreaConfiguration” in which dormant beams can be detected. The “dormant Beam Area Configuration” may comprise a number of cells with energy saving mode activated (where some of the supported beams are dormant).

In some examples, if the “dormantBeamList” or the “dormantBeamAreaConfiguration” is included in the logged MDT configuration, the apparatus 110 may only collect information from dormant beams limited by the logged MDT configuration. If those two fields are not included in the logged MDT configuration, the apparatus 110 may monitor beams in an unrestricted way.

In some examples, the logged MDT configuration in the present disclosure is provided by extending legacy logged MDT configuration beyond detection of “out of coverage by a UE” (also called as “any cell selection state”). In the “any cell selection state”, the UE cannot detect a suitable cell to connect to because it is out of coverage.

In the legacy logged MDT configuration, the value “outOfCoverage” indicates a UE to perform logging of measurements when the UE enters any cell selection state, and the value eventL1 indicates the UE to perform logging of measurements when the triggering condition as configured in the event is met for the camping cell in camped normally state.

According to the legacy logged MDT configuration, the UE logs the last cell it detects before it enters out of coverage state (i.e., any cell selection state) since the UE does not detect any cells and does not log anything during any cell selection state.

As described above, in the present disclosure, the “dormantBeamDetected” state is introduced to the legacy Logged MDT configuration. This allows the apparatus 110 to log measurement information on the at least one dormant beam when the apparatus 110 enters the “dormantBeamDetected” state. This entails different logging from the point of view of the apparatus 110.

According to the logged MDT configuration in the present disclosure, the apparatus 110 will not detect any beams to perform RACH to but will detect the at least one dormant beam which it will log while in the “dormantBeamDetected” state.

When the logged MDT configuration is initiated for energy saving, the apparatus 110 may provide the logged measurement information such that it distinguishes the two possible states, i.e., the “any cell selection state” and the “dormantBeamDetected” state. In the “any cell selection state”, the apparatus 110 cannot detect a suitable cell to connect to because it is out of coverage. In the “dormantBeamDetected” state, the apparatus 110 cannot detect a cell because the cell's beams are in a dormant state.

Since the logged MDT configuration is initiated for energy saving in the present disclosure, the apparatus 110 will distinguish the cause of an out of coverage by further indicating if this is due to a beam being in a dormant state. Thus, in some examples, if the apparatus 110 detects the “any cell selection state”, the apparatus 110 may skip logging measurement information on the any cell selection state.

With continued reference to FIG. 6, at block 620, the apparatus 110 monitors a reference signal of at least one beam in accordance with the configuration.

In some examples, the apparatus 110 may monitor the reference signal of the at least one beam in response to receiving a logged measurement activation.

In such examples, the logged measurement activation may comprise an energy saving indication indicating the apparatus 110 to collect information for an energy saving operation. The logged measurement activation may also comprise an Area Scope. The Area Scope may be set to be the “dormantBeamAreaConfiguration” (i.e., a set of cells comprising the at least one dormant beam).

The beam targeted by the present disclosure may be of any reference signal type such as an SSB beam, a Channel State Information Reference Signal (CSI-RS) beam, a Tracking Reference Signal (TRS) beam, a Phase-tracking reference signal (PT-RS) beam, or of a new reference signal type that may be defined in future releases/technologies. When such beam of a first reference signal type (e.g. SSB) is dormant, the access node 120 and/or 130 may transmit reference signals of a second type for the beam. The second type may be the same as the first type (for example, SSB, which may be sent e.g. with a relaxed periodicity, or in an incomplete manner for example including PSS/SSS only), or it may be different from the first type (e.g. of a dormant type such as a discovery reference signal type, DRS).

In some examples, the apparatus 110 may determine a beam is dormant by determining an RS of the beam is of a dormant type. For example, if the apparatus 110 detects that the RS of the beam is a beam-tracking RS defined for dormant beams, the apparatus 110 may determine the beam is dormant. The beam-tracking RS may comprise at least one of the following: PSS and SSS. The beam-tracking RS may not be used for initial access of the apparatus 110.

In some examples, the apparatus 110 may determine the beam is a dormant beam by determining at least one common channel or signal of the beam is not transmitted. For example, MIB or SIB 1 may not be transmitted for a dormant beam. MIB or SIB 1 may contain a signal for initial access. Thus, a signal for initial access may not be transmitted for a dormant beam. Thereby, the beam may be distinguished from normal (i.e., non-dormant) beams by the apparatus 110 since it transmits different information and it may not allow initial access.

In some examples, the apparatus 110 may determine the beam is a dormant beam by receiving an indication of dormancy for the beam from the access node 120.

In some examples, the apparatus 110 may monitor the reference signal of the at least one beam in response to receiving a logged measurement activation.

In such examples, the logged measurement activation may comprise an energy saving indication indicating the apparatus 110 to collect information for an energy saving operation. The logged measurement activation may also comprise an Area Scope. The Area Scope may be set to be the “dormantBeamAreaConfiguration” (i.e., a set of cells comprising the at least one dormant beam).

In some examples, the dormant beam may be an SSB beam or CSI-RS beam.

In some examples, the apparatus 110 may determine a beam is dormant by determining an RS of the beam is of a dormant type. For example, if the apparatus 110 detects that the RS of the beam is a beam-tracking RS defined for dormant beams, the apparatus 110 may determine the beam is dormant. The beam-tracking RS may comprise at least one of the following: PSS and SSS. The beam-tracking RS may not be used for initial access of the apparatus 110.

In some examples, the apparatus 110 may determine the beam is dormant by determining at least one common channel or signal of the beam is not transmitted. For example, MIB or SIB1 may not be transmitted for a dormant beam. MIB or SIB1 may contain a signal for initial access. Thus, a signal for initial access may not be transmitted for a dormant beam. Thereby, the beam may be distinguished from normal (i.e., non-dormant) beams by the apparatus 110 since it transmits different information and it may not allow initial access.

In some examples, the apparatus 110 may determine the beam is dormant by receiving an indication of dormancy for the beam from the access node 120.

At block 630, when detecting the at least one beam is dormant, the apparatus 110 logs measurement information on the at least one beam which is dormant. Hereinafter, a beam which is dormant is also referred to as “a dormant beam”. In other words, terms “a beam which is dormant” and “a dormant beam” may be used interchangeably.

In some examples, the logged measurement information on the at least one dormant beam may comprise at least one of the following: an identifier of the at least one dormant beam, an identifier of a beam-tracking RS detected for the at least one dormant beam, a time stamp when the at least one dormant beam was monitored, a time duration when the at least one dormant beam was monitored by the apparatus 110, amount of data to be transmitted by the apparatus 110 during the time duration, or a location of the apparatus 110.

Alternatively, or additionally, in some examples, the logged measurement information may comprise at least one of the following: a first indication whether the apparatus 110 had transmitted a wake-up signal to the at least one dormant beam and obtained no response, or time when the wake-up signal was transmitted.

Alternatively, or additionally, in some examples, the logged measurement information may comprise at least one of the following:
a second indication whether the apparatus 110 used a non-dormant beam or a non-dormant cell for transmitting data,
an identifier of the non-dormant beam or the non-dormant cell,
an identifier of a strongest non-dormant beam detected along with the at least one dormant beam,
an identifier of a cell comprising the strongest non-dormant beam,
radio quality of the at least one dormant beam, or
radio quality of the strongest non-dormant beam.

At block 640, the apparatus 110 transmits the logged measurement information to the access node.

In some examples, the apparatus 110 may transmit, to the access node 120, a logged MDT report comprising the logged measurement information.

In some examples, the apparatus 110 may get back to a connected state after coverage is recovered. For example, the apparatus 110 may get back to the connected state by transmitting a wake-up signal to the access node 120 if the “dormantBeamDetected” trigger is met. In turn, the apparatus 110 may transmit the logged measurement information in the connected state.

Alternatively, the apparatus 110 may transmit the logged measurement information in an inactive state. For example, the logged measurement information may be provided as part of a small data transmission procedure while the apparatus 110 remains in the inactive state.

In some examples, the apparatus 110 may transmit the logged measurement information upon receiving a request for the logged measurement information from the access node 120.

In some examples, before transmitting the logged measurement information, the apparatus 110 may transmit, to the access node 120, an indication that the logged measurement information on the at least one dormant beam is available. For example, the indication may be a loggedMeasurementAvailability indicator.

In some examples, the apparatus 110 may transmit the indication that the logged measurement information is available by transmitting a wake-up signal to the access node 120. The wake-up signal comprises the indication. For example, the indication may be piggy-backed in the wake-up signal from the apparatus 110. For another example, the indication may be indicated in the wake-up signal from the apparatus 110.

In some examples, the apparatus 110 may transmit the indication that the logged measurement information is available by transmitting the indication after transmitting a wake-up signal to the access node 120.

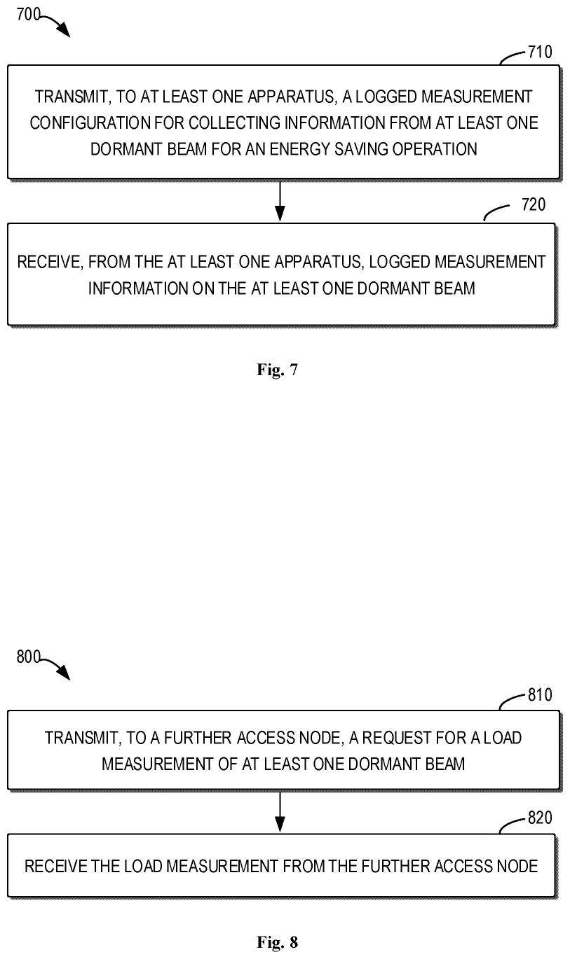

FIG. 7 shows a flowchart of an example method 700 implemented at the access node 120 as shown in FIG. 1.

At block 710, the access node 120 transmits, to at least one apparatus, a logged measurement configuration for collecting information from at least one dormant beam for an energy saving operation.

In some examples, the logged measurement configuration may be referred to as a logged MDT configuration.

In some examples, before transmitting the logged MDT configuration to the apparatus 110, the access node 120 may obtain the logged MDT configuration from the management node 140. In turn, the access node 120 may store the logged MDT configuration and parameters in the logged MDT configuration.

In some examples, the logged MDT configuration may be a signaling-based MDT which is targeting a specific UE (such as the apparatus 110-1). Alternatively, the logged MDT configuration may be a management-based MDT which is targeting an area of cells that may comprise a group of UEs (such as the apparatuses 110-1 and 110-2).

In some examples, the access node 120 may transmit the logged MDT configuration to a plurality of apparatuses meeting area constraints, such as the apparatuses 110-1 and 110-2.

In examples where the signaling-based MDT configuration is used, apparatuses receiving the configuration may be determined by the management node 140 using identifiers of the apparatuses and are apparatuses that have provided the needed user consent. Examples of the identifiers may comprise at least one of the following: IMSI/IMEI/SUPI.

In examples where the management-based MDT is used, in baseline MDT procedures, apparatuses receiving the configuration may be selected by the access node 120 in an implementation specific way such that the apparatuses meet the area requirements.

In some examples, the access node 120 may transmit the logged MDT configuration to the apparatus 110 that has been connected to a cell in energy saving mode (for example, a cell that has put some beams in dormancy).

In some examples, the logged MDT configuration may be provided as follows:

```
LoggedEventTriggerConfig-r18 ::=  SEQUENCE {
  eventType-r18  EventType-r18,
  loggingInterval-r18  LoggingInterval-r18,
  . . .
}
EventType-r18 ::= CHOICE {
  dormantBeamDetected  NULL,
  dormantBeamList BeamList  OPTIONAL
  dormantBeamAreaConfiguration Area Configuration OPTIONAL // this can be an
alternative to dormantBeamList
  . . .
}
```

The event “dormantBeamDetected” indicates the apparatus 110 to log measurement information on the at least one dormant beam when the apparatus 110 enters a “dormantBeamDetected” state. In some examples, the apparatus 110 enters the “dormantBeamDetected” state the first time it detects a dormant beam. If the apparatus 110 detects a non-dormant beam, it could exit the “dormantBeamDetected” state and attempt connection to the beam. But if the apparatus 110 does not attempt connection to the access node 120, then it skips logging information of the non-dormant beam and continues the monitoring of dormant beams.

In some examples, the event “dormantBeamDetected” may be detected in a limited set of dormant beams (provided by the “dormantBeamList” in the configuration) or by defining the “dormantBeamAreaConfiguration” in which dormant beams can be detected. The “dormant Beam Area Configuration” may comprise a number of cells with energy saving mode activated (where some of the supported beams are dormant).

In some examples, if the “dormantBeamList” or the “dormantBeamAreaConfiguration” is included in the logged MDT configuration, the apparatus 110 may only collect information from dormant beams limited by the indicated cells in the logged MDT configuration. If those two fields are not included in the logged MDT configuration, the apparatus 110 may monitor beams in an unrestricted way.

At block 720, the access node 120 receives, from the at least one apparatus, logged measurement information on the at least one dormant beam.

In some examples, the logged measurement information on the at least one dormant beam may comprise at least one of the following: an identifier of the at least one dormant beam, an identifier of a beam-tracking RS detected for the at least one dormant beam, a time stamp when the at least one dormant beam was monitored, a time duration when the at least one dormant beam was monitored by the apparatus 110, amount of data to be transmitted by the apparatus 110 during the time duration, or a location of the apparatus 110.

Alternatively, or additionally, in some examples, the logged measurement information may comprise at least one of the following: a first indication whether the apparatus 110 had transmitted a wake-up signal to the at least one dormant beam and obtained no response, or time when the wake-up signal was transmitted.

Alternatively, or additionally, in some examples, the logged measurement information may comprise at least one of the following:
a second indication whether the apparatus 110 used a non-dormant beam or a non-dormant cell for transmitting data,
an identifier of the non-dormant beam or the non-dormant cell,
an identifier of a strongest non-dormant beam detected along with the at least one dormant beam,
an identifier of a cell comprising the strongest non-dormant beam,
radio quality of the at least one dormant beam, or
radio quality of the strongest non-dormant beam.

In some examples, before receiving the logged measurement information, the access node 120 may receive, from the at least one apparatus, an indication that the logged measurement information on the at least one dormant beam is available.

In some examples, the access node 120 may receive the indication that the logged measurement information on the at least one dormant beam is available by receiving a wake-up signal from the at least one apparatus. The wake-up signal comprises the indication.

In some examples, the access node 120 may receive the indication that the logged measurement information on the at least one dormant beam is available by receiving the indication after receiving a wake-up signal from the at least one apparatus.

In some examples, the access node 120 may determine a load measurement of the at least one dormant beam based at least on the logged measurement information received from at least one apparatus.

In some examples, the access node 120 may receive, from the access node 130, a request for the load measurement of the at least one dormant beam. In turn, the access node 120 may transmit the load measurement to the access node 130 based on the request.

In some examples, the access node 120 may receive the request for the load measurement by receiving a RESOURCE STATUS REQUEST message. It shall be understood that the RESOURCE STATUS REQUEST message is just an example, and other messages can be similarly used.

In some examples, the request for the load measurement may indicate at least one of the following: measurement ID of the access node 130, a “cells to report list” or an indication that the load measurement of the at least one dormant beam is to be reported.

In some examples, the “cells to report list” may comprise a set of cells where the at least one dormant beam is monitored.

Upon receiving the request, the access node 120 may determine whether it is capable to provide the load measurement of the at least one dormant beam. If the access node 120 is capable to provide the load measurement, the access node 120 initiates the load measurement as requested by the access node 130, and responds to the access node 130 with a response. In some examples, the access node 120 may transmit the response by transmitting a RESOURCE STATUS RESPONSE message. It shall be understood that the RESOURCE STATUS RESPONSE message is just an example, and other messages can be similarly used.

In some examples, the access node 120 may transmit, to the access node 130, the “cells to report list” and the load measurement of the at least one dormant beam. As mentioned above, the “cells to report list” may comprise a set of cells where the at least one dormant beam is monitored.

In some examples, the load measurement of the at least one dormant beam may indicate the number of apparatuses monitoring a first dormant beam among the at least one dormant beam.

In some examples, based at least on the logged measurement information received from a plurality of apparatuses (such as UEs), the access node 120 may determine how many apparatuses have been monitoring different beam-tracking RSs it broadcasts and how long the apparatuses have been monitoring the beam-tracking RSs. In turn, the access node 120 may determine a “Dormant Beam Load” of UEs monitoring the beam-tracking RSs.

In this way, the access node 120 may determine a Dormant Beam Load per beam-tracking RS. If the Dormant Beam Load is high enough (for example, exceeding a threshold value), then the beam corresponding to the beam-tracking RS is a good candidate to be woken up in case of a handover. This threshold value may be configured by OAM to the access node 120.

Alternatively, or additionally, in some examples, the load measurement of the at least one dormant beam may indicate amounts of data (i.e., traffic) to be transmitted by the apparatuses (such as UEs) monitoring the first dormant beam.

In some examples, the access node 120 may determine, based on the load measurement, a predicted load measurement of the at least one dormant beam at a future time.

In some examples, the access node 120 may determine the predicted load measurement of the at least one dormant beam by using a machine learning (ML) model. In such examples, the load measurement may be used as an input of the ML model and the predicted load measurement may be an output of the ML model. In some examples, supervised models may be used to train an ML algorithm.

In some examples, the input of the ML model may comprise information on how long a dormant beam is monitored, from how many apparatuses (such as UEs) it is monitored and when it needs to be activated. Base on the information, the access node 120 may determine a dormancy pattern of a beam in the future. For example, the access node 120 may determine whether the beam is active or dormant in an hour.

In some examples, the access node 120 may receive, from the access node 130, a request for the predicted load measurement of the at least one dormant beam. In turn, the access node 120 may transmit the predicted load measurement to the access node 130 based on the request.

In some examples, the access node 120 may determine whether to activate the at least one dormant beam based on at least one of the following: the load measurement or the predicted load measurement.

As mentioned above, the load measurement of the at least one dormant beam may indicate the number of UEs monitoring a dormant beam and/or the amount of data (i.e., traffic) to be transmitted if the dormant beam was activated. If there are many UEs that would benefit by activating the dormant beam, the access node 120 may consider to activate the dormant beam for the UEs which have already monitored the dormant beam.

FIG. 8 shows a flowchart of an example method 800 implemented at the access node 120 as shown in FIG. 1.

At block 810, the access node 130 transmits, to a further access node, a request for a load measurement of at least one dormant beam.

In some examples, the access node 130 may transmit the request for the load measurement by transmitting a RESOURCE STATUS REQUEST message. It shall be understood that the RESOURCE STATUS REQUEST message is just an example, and other messages can be similarly used.

In some examples, the request for the load measurement may indicate measurement ID of the access node 130, a “cells to report list” and an indication that the load measurement of the at least one dormant beam is to be reported.

In some examples, the “cells to report list” may comprise a set of cells where the at least one dormant beam is monitored.

At block 820, the access node 130 receives the load measurement from the further access node.

In some examples, the load measurement of the at least one dormant beam may indicate the number of apparatuses monitoring a first dormant beam among the at least one dormant beam.

Alternatively, or additionally, in some examples, the load measurement of the at least one dormant beam may indicate amounts of data to be transmitted by the apparatuses monitoring the first dormant beam.

In some examples, the access node 130 may determine, based on the received load measurement, a predicted load measurement of the at least one dormant beam at a future time. In turn, the access node 130 may determine, based on the predicted load measurement, whether to activate the at least one dormant beam or request activation of the at least one dormant beam.

In some examples, the access node 130 may receive, from the access node 120, a predicted load measurement of each of the at least one dormant beam at a future time. In turn, the access node 130 may determine, based on the predicted load measurement, whether to activate the at least one dormant beam or request activation of the at least one dormant beam.

In some examples, the access node 130 may determine whether the predicted load measurement is above a threshold. If the predicted load measurement is above the threshold, the access node 130 may transmit, to the access node 120, a request for activating the at least one dormant beam, or transmit, to the access node 130, a handover request or a conditional handover for the at least one dormant beam.

In some examples, an apparatus capable of performing any of the method 600 (for example, the apparatus 110) may comprise means for performing the respective operations of the method 600. The means may be implemented in any suitable form. For example, the means may be implemented in a circuitry or software module. The apparatus may be implemented as or included in the apparatus 110. In some examples, the means may comprise a processor and a memory.

In some examples, the apparatus comprises: means for receiving a logged measurement configuration, from an access node, for collecting information from at least one dormant beam for an energy saving operation; means for monitoring a reference signal of at least one beam in accordance with the configuration; means for logging measurement information on the at least one beam when detecting the at least one beam is dormant, and means for transmitting the logged measurement information to the access node.

In some examples, the logged measurement configuration may comprise at least one of the following: a list of the at least one beam which is dormant, or a list of at least one cell comprising the at least one beam which is dormant.

In some examples, the logged measurement information on the at least one dormant beam may comprise at least one of the following: an identifier of the at least one dormant beam, an identifier of a beam-tracking RS detected for the at least one dormant beam, a time stamp when the at least one dormant beam was monitored, a time duration when the at least one dormant beam was monitored by the apparatus, amount of data to be transmitted by the apparatus during the time duration, or a location of the apparatus.

Alternatively, or additionally, in some examples, the logged measurement information may comprise at least one of the following: a first indication whether the apparatus had transmitted a wake-up signal to the at least one dormant beam and obtained no response, or time when the wake-up signal was transmitted.

Alternatively, or additionally, in some examples, the logged measurement information may comprise at least one of the following:
a second indication whether the apparatus used a non-dormant beam or a non-dormant cell for transmitting data,
an identifier of the non-dormant beam or the non-dormant cell,
an identifier of a strongest non-dormant beam detected along with the at least one dormant beam,
an identifier of a cell comprising the strongest non-dormant beam,
radio quality of the at least one dormant beam, or
radio quality of the strongest non-dormant beam.

In some examples, the apparatus further comprises: means for transmitting, to the access node, an indication that the logged measurement information on the at least one beam is available before transmitting the logged measurement information. For example, the indication may be a loggedMeasurementAvailability indicator.

In some examples, the means for transmitting the indication that the logged measurement information on the at least one beam is available comprises: means for transmitting a wake-up signal to the access node. The wake-up signal comprises the indication.

In some examples, the means for transmitting the indication that the logged measurement information on the at least one beam is available comprises: means for transmitting the indication after transmitting a wake-up signal to the access node.

In some examples, the apparatus further comprises: means for skipping logging measurement information on an any cell selection state in accordance with a determination that the any cell selection state is detected.

In some examples, the apparatus further comprises: means for determining that the at least one beam is dormant by at least one of the following: determining a reference signal of the at least one beam is of a dormant type, determining at least one common channel or signal of the at least one beam is not transmitted, or receiving an indication of dormancy for the at least one beam from the access node.

In some examples, the means for monitoring the reference signal of the at least one beam comprises: means for monitoring the reference signal of the at least one beam in response to receiving a logged measurement activation.

In some examples, the means for transmitting the logged measurement information comprises: means for transmitting the logged measurement information when the apparatus in a connected state or inactive state.

In some examples, the means for transmitting the logged measurement information comprises: means for transmitting the logged measurement information upon receiving a request for the logged measurement information from the access node.

In some examples, an access node capable of performing any of the method 700 (for example, the access node 120) may comprise means for performing the respective operations of the method 700. The means may be implemented in any suitable form. For example, the means may be implemented in a circuitry or software module. The access node may be implemented as or included in the access node 120. In some examples, the means may comprise a processor and a memory.

In some examples, the access node comprises: means for transmitting, to at least one apparatus, a logged measurement configuration for collecting information from at least one dormant beam for an energy saving operation; and means for receiving, from the at least one apparatus, logged measurement information on the at least one dormant beam.

In some examples, the access node further comprises: means for determining a load measurement of the at least one dormant beam based at least on the logged measurement information.

In some examples, the access node further comprises: means for receiving, from a further access node, a request for the load measurement of the at least one dormant beam; and means for transmitting the load measurement to the further access node based on the request.

In some examples, the access node further comprises: means for determining, based on the load measurement, a predicted load measurement of the at least one dormant beam at a future time.

In some examples, the access node further comprises: means for receiving, from a further access node, a request for the predicted load measurement of the at least one dormant beam; and means for transmitting the predicted load measurement to the further access node based on the request.

In some examples, the access node further comprises: means for determining, based on the predicted load measurement, whether to activate the at least one dormant beam.

In some examples, the load measurement indicates at least one of the following: the number of apparatuses monitoring a first dormant beam among the at least one dormant beam, or amounts of data to be transmitted by the apparatuses monitoring the first dormant beam.

In some examples, the logged measurement configuration comprises at least one of the following: a list of the at least one dormant beam, or a list of at least one cell comprising the at least one dormant beam.

In some examples, the logged measurement information on the at least one dormant beam may comprise at least one of the following: an identifier of the at least one dormant beam, an identifier of a beam-tracking RS detected for the at least one dormant beam, a time stamp when the at least one dormant beam was monitored, a time duration when the at least one dormant beam was monitored by the apparatus, amount of data to be transmitted by the apparatus during the time duration, or a location of the apparatus.

Alternatively, or additionally, in some examples, the logged measurement information may comprise at least one of the following: a first indication whether the apparatus had transmitted a wake-up signal to the at least one dormant beam and obtained no response, or time when the wake-up signal was transmitted.

Alternatively, or additionally, in some examples, the logged measurement information may comprise at least one of the following:
a second indication whether the apparatus used a non-dormant beam or a non-dormant cell for transmitting data,
an identifier of the non-dormant beam or the non-dormant cell,
an identifier of a strongest non-dormant beam detected along with the at least one dormant beam,
an identifier of a cell comprising the strongest non-dormant beam, radio quality of the at least one dormant beam, or
radio quality of the strongest non-dormant beam.

In some examples, the access node further comprises: means for receiving, from the at least one apparatus, an indication that the logged measurement information on the at least one dormant beam is available before receiving the logged measurement information.

In some examples, the means for receiving the indication that the logged measurement information on the at least one dormant beam is available comprises: means for receiving a wake-up signal from the at least one apparatus. The wake-up signal comprises the indication.

In some examples, the means for receiving the indication that the logged measurement information on the at least one dormant beam is available comprises: means for receiving the indication after receiving a wake-up signal from the at least one apparatus.

In some examples, an access node capable of performing any of the method 800 (for example, the access node 130) may comprise means for performing the respective operations of the method 800. The means may be implemented in any suitable form. For example, the means may be implemented in a circuitry or software module. The access node may be implemented as or included in the access node 130. In some examples, the means may comprise a processor and a memory.

In some examples, the access node comprises: means for transmitting, to a further access node, a request for a load measurement of at least one dormant beam; and means for receiving the load measurement from the further access node.

In some examples, the load measurement indicates at least one of the following: the number of apparatuses monitoring a first dormant beam among the at least one dormant beam, or amounts of data to be transmitted by the apparatuses monitoring the first dormant beam.

In some examples, the access node further comprises: means for determining, based on the received load measurement, a predicted load measurement of the at least one dormant beam at a future time; and means for determining, based on the predicted load measurement, whether to activate the at least one dormant beam or request activation of the at least one dormant beam.

In some examples, the access node further comprises: means for receiving, from the further access node, a predicted load measurement of the at least one dormant beam at a future time; and means for determining, based on the predicted load measurement, whether to activate the at least one dormant beam or request activation of the at least one dormant beam.

In some examples, the access node further comprises: means for transmitting, to the further access node, a request for activating the at least one dormant beam when the predicted load measurement is above a threshold, or means for transmitting, to the further access node, a handover request or a conditional handover for the at least one dormant beam when the predicted load measurement is above a threshold.

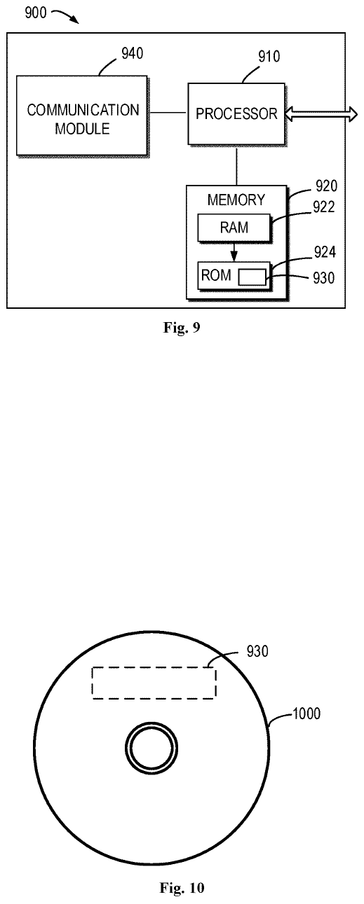

FIG. 9 is a simplified block diagram of a device 900 that is suitable for implementing examples of the present disclosure. The device 900 may be provided to implement a communication device, for example, the apparatus 110, the access node 120, or the access node 130 as shown in FIG. 1. As shown, the device 900 includes one or more processors 910, one or more memories 920 coupled to the processor 910, and one or more communication modules 940 coupled to the processor 910.

The communication module 940 is for bidirectional communications. The communication module 940 has one or more communication interfaces to facilitate communication with one or more other modules or devices. The communication interfaces may represent any interface that is necessary for communication with other network elements. In some examples, the communication module 940 may include at least one antenna.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 922 and other volatile memories that will not last in the power-down duration.

A computer program 930 includes computer executable instructions that could be executed by the associated processor 910. The program 930 may be stored in the memory, e.g., ROM 924. The processor 910 may perform any suitable actions and processing by loading the program 930 into the RAM 922.

The examples of the present disclosure may be implemented by means of the program 930 so that the device 900 may perform any process of the disclosure as discussed with reference to FIGS. 1 to 8. The examples of the present disclosure may also be implemented by hardware or by a combination of software and hardware.

In some examples, the program 930 may be tangibly contained in a computer readable medium which may be included in the device 900 (such as in the memory 920) or other storage devices that are accessible by the device 900. The device 900 may load the program 930 from the computer readable medium to the RAM 922 for execution. The computer readable medium may include any types of tangible non-volatile storage, such as ROM, EPROM, a flash memory, a hard disk, CD, DVD, and the like. FIG. 10 shows an example of the computer readable medium 1000 which may be in form of CD, DVD or other optical storage disk. The computer readable medium has the program 930 stored thereon.

Generally, various examples of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of examples of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target physical or virtual processor, to carry out any of the methods as described above with reference to FIGS. 1 to 8. Generally, program modules include routines, programs, libraries, objects, classes, components, data structures, or the like that perform particular tasks or implement particular abstract data types. The functionality of the program modules may be combined or split between program modules as desired in various examples. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

It should be appreciated that though some examples may be implemented by/at IAB nodes, solutions including methods and apparatus proposed in this disclosure could also be applied in other communication systems where similar technical problems exist. Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular examples. Certain features that are described in the context of separate examples may also be implemented in combination in a single example. Conversely, various features that are described in the context of a single example may also be implemented in multiple examples separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. An apparatus, comprising:
at least one processor; and
at least one memory storing instructions that, when executed by the at least one processor, cause the apparatus at least to:
receive a logged measurement configuration, from an access node, for collecting information from at least one dormant beam for an energy saving operation;
monitor a reference signal of at least one beam in accordance with the configuration;
when detecting the at least one beam is dormant, log measurement information on the at least one beam, and
transmit the logged measurement information to the access node.

2. The apparatus of claim 1, wherein the logged measurement configuration comprises at least one of the following:
a list of the at least one beam which is dormant, or
a list of at least one cell comprising the at least one beam which is dormant.

3. The apparatus of claim 1, wherein the logged measurement information on the at least one beam which is dormant comprises at least one of the following:
an identifier of the at least one beam which is dormant,
an identifier of a beam-tracking reference signal detected for the at least one beam which is dormant,
a time stamp when the at least one beam was monitored,
a time duration when the at least one beam was monitored by the apparatus,
amount of data to be transmitted by the apparatus during the time duration, or
a location of the apparatus,
a first indication whether the apparatus had transmitted a wake-up signal to the at least one beam which is dormant and obtained no response,
time when the wake-up signal was transmitted,
a second indication whether the apparatus used a non-dormant beam or a non-dormant cell for transmitting data,
an identifier of the non-dormant beam or the non-dormant cell,
an identifier of a strongest non-dormant beam detected along with the at least one beam which is dormant,
an identifier of a cell comprising the strongest non-dormant beam,
radio quality of the at least one beam which is dormant, or
radio quality of the strongest non-dormant beam.

4. The apparatus of claim 1, wherein the apparatus is further caused to:
before transmitting the logged measurement information, transmit, to the access node, an indication that the logged measurement information on the at least one beam is available.

5. The apparatus of claim 4, wherein the apparatus is caused to transmit the indication that the logged measurement information on the at least one beam is available by:
transmitting a wake-up signal to the access node, the wake-up signal comprising the indication.

6. The apparatus of claim 4, wherein the apparatus is caused to transmit the indication that the logged measurement information on the at least one beam is available by:
transmitting the indication after transmitting a wake-up signal to the access node.

7. The apparatus of claim 1, wherein the apparatus is further caused to:
in accordance with a determination that an any cell selection state is detected, skip logging measurement information on the any cell selection state.

8. The apparatus of claim 1, wherein the apparatus is further caused to determine that the at least one beam is dormant by at least one of the following:
determining a reference signal of the at least one beam is of a dormant type,
determining at least one common channel or signal of the at least one beam is not transmitted, or
receiving an indication of dormancy for the at least one beam from the access node.

9. The apparatus of claim 1, wherein the apparatus is caused to monitor the reference signal of the at least one beam in response to receiving a logged measurement activation.

10. The apparatus of claim 1, wherein the apparatus is caused to transmit the logged measurement information when the apparatus in a connected state or inactive state.

11. The apparatus of claim 1, wherein the apparatus is caused to transmit the logged measurement information upon receiving a request for the logged measurement information from the access node.

12. An access node, comprising:
at least one processor; and
at least one memory storing instructions that, when executed by the at least one processor, cause the access node at least to:
transmit, to at least one apparatus, a logged measurement configuration for collecting information from at least one dormant beam for an energy saving operation; and
receive, from the at least one apparatus, logged measurement information on the at least one dormant beam.

13. The access node of claim 12, wherein the access node is further caused to:
determine a load measurement of the at least one dormant beam based at least on the logged measurement information.

14-18. (canceled)

19. The access node of claim 12, wherein the logged measurement configuration comprises at least one of the following:
a list of the at least one dormant beam, or
a list of at least one cell comprising the at least one dormant beam.

20. The access node of claim 12, wherein the logged measurement information on the at least one dormant beam comprises at least one of the following:
an identifier of the at least one dormant beam,
an identifier of a beam-tracking reference signal detected for the at least one dormant beam,
a time stamp when the at least one dormant beam was monitored,
a time duration when the at least one dormant beam was monitored by one of the at least one apparatus,
amount of data to be transmitted by the one of the at least one apparatus during the time duration, or
a location of the one of the at least one apparatus,
a first indication whether the one of the at least one apparatus had transmitted a wake-up signal to the at least one dormant beam and obtained no response,
time when the wake-up signal was transmitted,
a second indication whether the one of the at least one apparatus used a non-dormant beam or a non-dormant cell for transmitting data,
an identifier of the non-dormant beam or the non-dormant cell,
an identifier of a strongest non-dormant beam detected along with the at least one dormant beam,
an identifier of a cell comprising the strongest non-dormant beam,
radio quality of the at least one dormant beam, or
radio quality of the strongest non-dormant beam.

21. The access node of claim 12, wherein the access node is further caused to:
before receiving the logged measurement information, receive, from the at least one apparatus, an indication that the logged measurement information on the at least one dormant beam is available.

22-23. (canceled)

24. An access node, comprising:
at least one processor; and
at least one memory storing instructions that, when executed by the at least one processor, cause the access node at least to:
transmit, to a further access node, a request for a load measurement of at least one dormant beam; and
receive the load measurement from the further access node.

25. The access node of claim 24, wherein the load measurement indicates at least one of the following:
the number of apparatuses monitoring a first dormant beam among the at least one dormant beam, or
amounts of data to be transmitted by the apparatuses monitoring the first dormant beam.

26. The access node of claim 24, wherein the access node is further caused to:
determine, based on the received load measurement, a predicted load measurement of the at least one dormant beam at a future time; and
determine, based on the predicted load measurement, whether to activate the at least one dormant beam or request activation of the at least one dormant beam.

27. The access node of claim 24, wherein the access node is further caused to:
receive, from the further access node, a predicted load measurement of the at least one dormant beam at a future time; and
determine, based on the predicted load measurement, whether to activate the at least one dormant beam or request activation of the at least one dormant beam.

28-31. (canceled)
